(19) United States
(12) Patent Application Publication
(10) Pub. No.: US 2017/0031940 A1
(43) Pub. Date: Feb. 2, 2017

(54) COMPRESSION FILE STRUCTURE

(71) Applicant: NetApp, Inc., Sunnyvale, CA (US)

(72) Inventors: Ananthan SUBRAMANIAN, San Ramon, CA (US); Sandeep YADAV, Santa Clara, CA (US); Manish KATIYAR, Santa Clara, CA (US)

(73) Assignee: NETAPP, INC., Sunnyvale, CA (US)

(21) Appl. No.: 14/815,903

(22) Filed: Jul. 31, 2015

(51) Int. Cl. G06F 17/30

(52) U.S. Cl. CPC G06F 17/30138; G06F 17/30091

(57) ABSTRACT

A file system layout apportions an underlying physical volume into one or more virtual volumes of a storage system. The virtual volumes having a file system and one or more files organized as buffer trees, the buffer trees utilizing indirect blocks to point to the data blocks. The indirect block at the level above the data blocks are grouped into compression groups that point to a set of physical volume block number (pvbn) block pointers.

### FIELD

The disclosure relates to file systems, and more specifically, a file system layout that is optimized for compression.

### BACKGROUND

The following description includes information that may be useful in understanding the present disclosure. It is not an admission that any of the information provided herein is prior art or relevant to the present disclosure, or that any publication specifically or implicitly referenced is prior art.

### File Server or Filer

A file server is a computer that provides file service relating to the organization of information on storage devices, such as disks. The file server or filer includes a storage operating system that implements a file system to logically organize the information as a hierarchical structure of directories and files on the disks. Each “on-disk” file may be implemented as a set of data structures, e.g., disk blocks, configured to store information. A directory, on the other hand, may be implemented as a specially formatted file in which information about other files and directories are stored.

A filer may be further configured to operate according to a client/server model of information delivery to thereby allow many clients to access files stored on a server, e.g., the filer. In this model, the client may comprise an application, such as a database application, executing on a computer that “connects” to the filer over a direct connection or computer network, such as a point-to-point link, shared local area network (LAN), wide area network (WAN), or virtual private network (VPN) implemented over a public network such as the Internet. Each client may request the services of the file system on the filer by issuing file system protocol messages (in the form of packets) to the filer over the network. Each client may request the services of the file system by issuing file system protocol messages (in the form of packets) to the storage system over the network. By supporting a plurality of file system protocols, such as the conventional Common Internet File System (CIFS) and the Network File System (NFS) protocols, the utility of the storage system is enhanced.

### Storage Operating System

As used herein, the term “storage operating system” generally refers to the computer-executable code operable on a computer that manages data access and may, in the case of a filer, implement file system semantics, such as a Write Anywhere File Layout (WAFL™) file system. The storage operating system can also be implemented as an application program operating over a general-purpose operating system, such as UNIX® or Windows NT®, or as a general-purpose operating system with configurable functionality, which is configured for storage applications as described herein.

The storage operating system of the storage system may implement a high-level module, such as a file system, to logically organize the information stored on the disks as a hierarchical structure of directories, files and blocks. For example, each “on-disk” file may be implemented as set of data structures, i.e., disk blocks, configured to store information, such as the actual data for the file. These data blocks are organized within a volume block number (vbn) space that is maintained by the file system. The file system may also assign each data block in the file a corresponding file block number (fbn). The file system typically assigns sequences of fbns on a per-file basis, whereas vbns are assigned over a larger volume address space. The file system organizes the data blocks within the vbn space as a “logical volume”; each logical volume may be, although is not necessarily, associated with its own file system. The file system typically consists of a contiguous range of vbns from zero to n, for a file system of size n−1 blocks.

A common type of file system is a “write in-place” file system, an example of which is the conventional Berkeley fast file system. By “file system” it is meant generally a structuring of data and metadata on a storage device, such as disks, which permits reading/writing of data on those disks. In a write in-place file system, the locations of the data structures, such as inodes and data blocks, on disk are typically fixed. An inode is a data structure used to store information, such as metadata, about a file, whereas the data blocks are structures used to store the actual data for the file. The information contained in an inode may include, e.g., ownership of the file, access permission for the file, size of the file, file type and references to locations on disk of the data blocks for the file. The references to the locations of the file data are provided by pointers in the inode, which may further reference indirect blocks that, in turn, reference the data blocks, depending upon the quantity of data in the file. Changes to the inodes and data blocks are made “in-place” in accordance with the write in-place file system. If an update to a file extends the quantity of data for the file, an additional data block is allocated and the appropriate inode is updated to reference that data block.

Another type of file system is a write-anywhere file system that does not overwrite data on disks. If a data block on disk is retrieved (read) from disk into memory and “dirtied” with new data, the data block is stored (written) to a new location on disk to thereby optimize write performance. A write-anywhere file system may initially assume an optimal layout such that the data is substantially contiguously arranged on disks. The optimal disk layout results in efficient access operations, particularly for sequential read operations, directed to the disks.

Write anywhere type file systems use many of the same basic data structures as transitional UNIX style file systems such as FFS or ext2. Each file is described by an indode, which contains per-file metadata and pointers to data or indirect blocks. For small files, the node points directly to the data blocks. For larger files, the inode points to trees of direct blocks. The file system may contain a superblock, that contains the inode describing the inode file, which in turn contains the inodes for all of the other files in the file system, including the other metadata files. Any data or metadata can be located by transversing the tree rooted at the superblock. As long as the super block or volume information block can be located, any of the other blocks can be allocated in other places.

When writing a block to disk (data or metadata) the write anywhere system never overwrites the current version of that block. Instead, the new value of each block is written to an unused location on disk. Thus each time the system writes a block, it must also update any block that points to the old location of the block. These updates recursively create a chain of block updates that reaches all the way up to the superblock.

### Physical Disk Storage

Disk storage is typically implemented as one or more storage “volumes” that comprise physical storage disks, defining an overall logical arrangement of storage space. Currently available filer implementations can serve a large number of discrete volumes (150 or more, for example). Each volume is associated with its own file system and, for purposes hereof, volume and file system shall generally be used synonymously. The disks within a volume are typically organized as one or more groups of Redundant Array of Independent (or Inexpensive) Disks (RAID). RAID implementations enhance the reliability/integrity of data storage through the redundant writing of data “stripes” across a given number of physical disks in the RAID group, and the appropriate caching of parity information with respect to the striped data. In the example of a WAFL file system, a RAID 4 implementation is advantageously employed. This implementation specifically entails the striping of data across a group of disks, and separate parity caching within a selected disk of the RAID group. As described herein, a volume typically comprises at least one data disk and one associated parity disk (or possibly data/parity partitions in a single disk) arranged according to a RAID 4, or equivalent high-reliability, implementation.

### Accessing Physical Blocks

When accessing a block of a file in response to servicing a client request, the file system specifies a vbn that is translated at the file system/RAID system boundary into a disk block number (dbn) location on a particular disk (disk, dbn) within a RAID group of the physical volume. Each block in the vbn space and in the dbn space is typically fixed, e.g., 4 k bytes (kB), in size; accordingly, there is typically a one-to-one mapping between the information stored on the disks in the dbn space and the information organized by the file system in the vbn space. The (disk, dbn) location specified by the RAID system is further translated by a disk driver system of the storage operating system into a plurality of sectors (e.g., a 4 kB block with a RAID header translates to 8 or 9 disk sectors of 512 is or 520 bytes) on the specified disk.

The requested block may then be retrieved from disk and stored in a buffer cache of the memory as part of a buffer tree of the file. The buffer tree is an internal representation of blocks for a file stored in the buffer cache and maintained by the file system. Broadly stated, the buffer tree has an inode at the root (top-level) of the file. An inode is a data structure used to store information, such as metadata, about a file, whereas the data blocks are structures used to store the actual data for the file. The information contained in an inode may include, e.g., ownership of the file, access permission for the file, size of the file, file type and references to locations on disk of the data blocks for the file. The references to the locations of the file data are provided by pointers, which may further reference indirect blocks that, in turn, reference the data blocks, depending upon the quantity of data in the file. Each pointer may be embodied as a vbn to facilitate efficiency among the file system and the RAID system when accessing the data on disks.

The RAID system maintains information about the geometry of the underlying physical disks (e.g., the number of blocks in each disk) in raid labels stored on the disks. The RAID system provides the disk geometry information to the file system for use when creating and maintaining the vbn-to-disk, dbn mappings used to perform write allocation operations and to translate vbns to disk locations for read operations. Block allocation data structures, such as an active map, a snapmap, a space map and a summary map, are data structures that describe block usage within the file system, such as the write-anywhere file system. These mapping data structures are independent of the geometry and are used by a write allocator of the file system as existing infrastructure for the logical volume.

Specifically, the snapmap denotes a file including a bitmap associated with the vacancy of blocks of a snapshot. The write-anywhere file system has the capability to generate a snapshot of its active file system. An “active file system” is a file system to which data can be both written and read, or, more generally, an active store that responds to both read and write I/O operations. It should be noted that “snapshot” is a trademark of Network Appliance, Inc. and is used for purposes of this patent to designate a persistent consistency point (CP) image. A persistent consistency point image (PCPI) is a space conservative, point-in-time read-only image of data accessible by name that provides a consistent image of that data (such as a storage system) at some previous time. More particularly, a PCPI is a point-in-time representation of a storage element, such as an active file system, file or database, stored on a storage device (e.g., on disk) or other persistent memory and having a name or other identifier that distinguishes it from other PCPIs taken at other points in time. In the case of the WAFL file system, a PCPI is always an active file system image that contains complete information about the file system, including all metadata. A PCPI can also include other information (metadata) about the active file system at the particular point in time for which the image is taken. The terms “PCPI” and “snapshot” may be used interchangeably throughout this patent without derogation of Network Appliance's trademark rights.

The write-anywhere file system supports multiple snapshots that are generally created on a regular schedule. Each snapshot refers to a copy of the file system that diverges from the active file system over time as the active file system is modified. In the case of the WAFL file system, the active file system diverges from the snapshots since the snapshots stay in place as the active file system is written to new disk locations. Each snapshot is a restorable version of the storage element (e.g., the active file system) created at a predetermined point in time and, as noted, is “read-only” accessible and “space-conservative”. Space conservative denotes that common parts of the storage element in multiple snapshots share the same file system blocks. Only the differences among these various snapshots require extra storage blocks. The multiple snapshots of a storage element are not independent copies, each consuming disk space; therefore, creation of a snapshot on the file system is instantaneous, since no entity data needs to be copied. to Read-only accessibility denotes that a snapshot cannot be modified because it is closely coupled to a single writable image in the active file system. The closely coupled association between a file in the active file system and the same file in a snapshot obviates the use of multiple “same” files. In the example of a WAFL file system, snapshots are described in TR3002 File System Design for a NFS File Server Appliance by David Hitz et is al., published by Network Appliance, Inc. and in U.S. Pat. No. 5,819,292 entitled. Method for Maintaining Consistent States of a File System and For Creating User-Accessible Read-Only Copies of a File System, by David Hitz et al., each of which is hereby incorporated by reference as though full set forth herein.

Changes to the file system are tightly controlled to maintain the file system in a consistent state. The file system progresses from one self-consistent state to another self-consistent state. The set of self-consistent blocks on disk that is rooted by the root inode is referred to as a consistency point (CP). To implement consistency points, WAFL always writes new data to unallocated blocks on disk. It never overwrites existing data. A new consistency point occurs when the fsinfo block is updated by writing a new root inode for the inode file into it. Thus, as long as the root inode is not updated, the state of the file system represented on disk does not change.

The system may also create snapshots, which are virtual read-only copies of the file system. A snapshot uses no disk space when it is initially created. It is designed so that many different snapshots can be created for the same file system. Unlike prior art file systems that create a clone by duplicating the entire inode file and all of the indirect blocks, the present disclosure duplicates only the inode that describes the inode file. Thus, the actual disk space required for a snapshot is only the 128 bytes used to store the duplicated inode. The 128 bytes of the present disclosure required for a snapshot is significantly less than the many megabytes used for a clone in the prior art.

Some file systems prevent new data written to the active file system from overwriting “old” data that is part of a snapshot(s). It is necessary that old data not be overwritten as long as it is part of a snapshot. This is accomplished by using a multi-bit free-block map. Some file systems use a free block map having a single bit per block to indicate whether or not a block is allocated. Other systems use a block map having 32-bit entries. A first bit indicates whether a block is used by the active file system, and 20 remaining bits are used for up to 20 snapshots, however, some bits of the 31 bits may be used for other purposes.

The active map denotes a file including a bitmap associated with a free status of the active file system. As noted, a logical volume may be associated with a file system; the term “active file system” refers to a consistent state of a current file system. The summary map denotes a file including an inclusive logical OR bitmap of all snapmaps. By examining the active and summary maps, the file system can determine whether a block is in use by either the active file system or any snapshot. The space map denotes a file including an array of numbers that describe the number of storage blocks used (counts of bits in ranges) in a block allocation area. In other words, the space map is essentially a logical OR bitmap between the active and summary maps to provide a condensed version of available “free block” areas within the vbn space. Examples of snapshot and block allocation data structures, such as the active map, space map and summary map, are described in U.S. Patent Application Publication No. US2002/0083037, titled Instant Snapshot, by Blake Lewis et al. and published on Jun. 27, 2002, now issued as U.S. Pat. No. 7,454,445 on Nov. 18, 2008, which application is hereby incorporated by reference.

The write anywhere file system includes a write allocator that performs write allocation of blocks in a logical volume in response to an event in the file system (e.g., dirtying of the blocks in a file). The write allocator uses the block allocation data structures to select free blocks within its vbn space to which to write the dirty blocks. The selected blocks are generally in the same positions along the disks for each RAID group (i.e., within a stripe) so as to optimize use of the parity disks, Stripes of positional blocks may vary among other RAID groups to, e.g., allow overlapping of parity update operations. When write allocating, the file system traverses a small portion of each disk (corresponding to a few blocks in depth within each disk) to essentially “lay down” a plurality of stripes per RAID group. In particular, the file system chooses vbns that are on the same stripe per RAID group during write allocation using the vbn-to-disk, dbn mappings.

When write allocating within the volume, the write allocator typically works down a RAID group, allocating all free blocks within the stripes it passes over. This is efficient from a RAID system point of view in that more blocks are written per stripe. It is also efficient from a file system point of view in that modifications to block allocation metadata are concentrated within a relatively small number of blocks. Typically, only a few blocks of metadata are written at the write allocation point of each disk in the volume. As used herein, the write allocation point denotes a general location on each disk within the RAID group (e.g., a stripe) where write operations occur.

Write allocation is performed in accordance with a conventional write allocation procedure using the block allocation bitmap structures to select free blocks within the vbn space of the logical volume to which to write the dirty blocks. Specifically, the write allocator examines the space map to determine appropriate blocks for writing data on disks at the write allocation point. In addition, the write allocator examines the active map to locate free blocks at the write allocation point. The write allocator may also examine snapshotted copies of the active maps to determine snapshots that may be in the process of being deleted.

According to the conventional write allocation procedure, the write allocator chooses a vbn for a selected block, sets a bit in the active map to indicate that the block is in use and increments a corresponding space map entry which records, in concentrated fashion, where blocks are used. The write allocator then places the chosen vbn into an indirect block or inode file “parent” of the allocated block. Thereafter, the file system “frees” the dirty block, effectively returning that block to the vbn space. To free the dirty block, the file system typically examines the active map, space map and a summary map. The file system then clears the bit in the active map corresponding to the freed block, checks the corresponding bit in the summary map to determine if the block is totally free and, if so, adjusts (decrements) the space map.

### Compression of Data

Compression of data groups data blocks together to make a compression group. The data blocks in the compression group are compressed in a smaller number of physical data blocks than the number of logical data blocks. The compression is performed by one or more methods commonly known in the art. For example, methods such as Huffman encoding, Lempel-Ziv methods, Lempel-Ziv-Welch methods, algorithms based on the Burrows-Wheeler transform, arithmetic coding, etc. A typical compression group requires 8 (eight) logical data blocks to be grouped together such that compressed data can be stored in less than 8 physical data blocks. This mapping between physical data blocks and logical data blocks requires the compression groups to be written as a single data block. Therefore, the compression group is written to disk in full.

When a compression group is partially written by a user (e.g., one logical data block is modified in a compression group of 8 logical data blocks), all physical data blocks in the compression group are read, the physical data blocks in the compression group are uncompressed, and the modified data block is merged with the uncompressed data. If the system is using inline compression, then compression of modified compression groups is performed immediately prior to writing out data to a disk, and the compressed groups are all written out to disk. If a system is using background compression, then the compression of a modified compression group is performed in the background once the compression group has been modified, and the compressed data is written to disk. Random partial writes (partial writes or overwrites to different compression groups) can therefore greatly affect performance of the storage system. Therefore, although compression provides storage savings, the degradation of performance may be disadvantageous enough to not do compression in a storage system.

### BRIEF DESCRIPTION OF THE DRAWINGS

The accompanying drawings, which are incorporated in and constitute a part of this specification, exemplify the embodiments of the present disclosure and, together with the description, serve to explain and illustrate principles of the disclosure. The drawings are intended to illustrate major features of the exemplary embodiments in a diagrammatic manner. The drawings are not intended to depict every feature of actual embodiments nor relative dimensions of the depicted elements, and are not drawn to scale.

FIG. 1 depicts, in accordance with various embodiments of the present disclosure, a diagram representing a storage system;

FIG. 2 depicts, in accordance with various embodiments of the present disclosure, a diagram of the mapping of data blocks to an inode using a tree of data block pointers;

FIG. 3 depicts, in accordance with various embodiments of the present disclosure, a diagram of a single compression group within an indirect block;

FIG. 4 depicts, in accordance with various embodiments of the present disclosure, a diagram of an indirect block referenced to compressed data;

FIG. 5 depicts, in accordance with various embodiments of the present disclosure, a diagram of an indirect block referenced to uncompressed data; and

FIG. 6 depicts, in accordance with various embodiments of the present disclosure, a diagram of an indirect block illustrating a partial overwrite of a compression group.

In the drawings, the same reference numbers and any acronyms identify elements or acts with the same or similar structure or functionality for ease of understanding and convenience. To easily identify the discussion of any particular element or act, the most significant digit or digits in a reference number refer to the Figure number in which that element is first introduced.

### DETAILED DESCRIPTION

Unless defined otherwise, technical and scientific terms used herein have the same meaning as commonly understood by one of ordinary skill in the art to which this disclosure belongs. One skilled in the art will recognize many methods and materials similar or equivalent to those described herein, which could be used in the practice of the present disclosure. Indeed, the present disclosure is in no way limited to the methods and materials specifically described.

Various examples of the disclosure will now be described. The following description provides specific details for a thorough understanding and enabling description of these examples. One skilled in the relevant art will understand, however, that the disclosure may be practiced without many of these details. Likewise, one skilled in the relevant art will also understand that the disclosure can include many other obvious features not described in detail herein. Additionally, some well-known structures or functions may not be shown or described in detail below, so as to avoid unnecessarily obscuring the relevant description.

The terminology used below is to be interpreted in its broadest reasonable manner, even though it is being used in conjunction with a detailed description of certain specific examples of the disclosure. Indeed, certain terms may even be emphasized below; however, any terminology intended to be interpreted in any restricted manner will be overtly and specifically defined as such in this Detailed Description section.

### Example Storage System

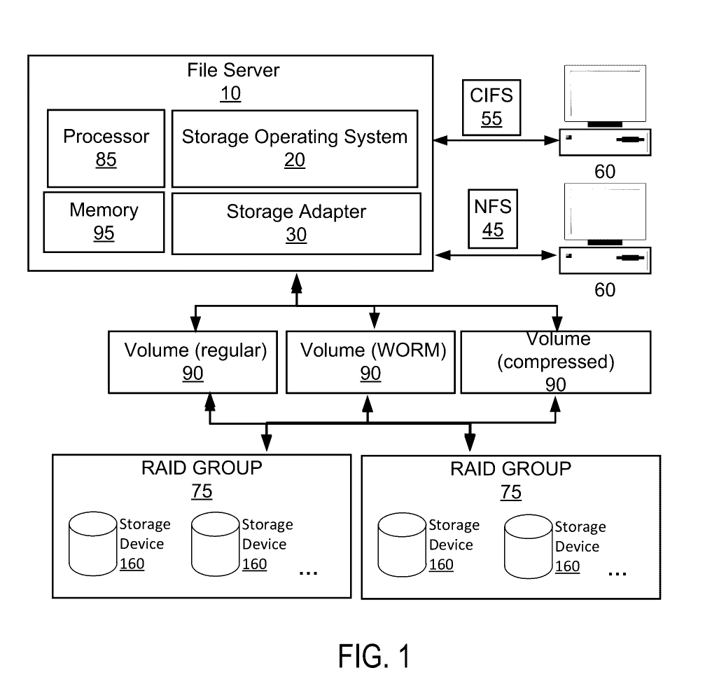

FIG. 1 illustrates an overview of an example of a storage system according to the present disclosure. The storage system may include a non-volatile storage such as a Redundant Array of Independent Disks (e.g., RAID system), one or more hard drives, one or more flash drives and/or one or more arrays. The storage system may be communicatively coupled to the host device as a Network Attached Storage (NAS) device, a Storage Area Network (SAN) device, and/or as a Direct Attached Storage (DAS) device.

In some embodiments, the storage system includes a file server 10 that administers a storage system. The file server 10 generally includes a storage adapter 30 and a storage operating system 20. The storage operating system 20 may be any suitable storage system to access and store data on a RAID or similar storage configuration such as the Data ONTAP™ operating system available from NetApp, Inc.

The storage adaptor 30 is interfaced with one or more RAID groups 75 or other mass storage hardware components. The RAID groups include storage devices 160. Examples of storage devices 160 include hard disk drives, non-volatile memories (e.g., flash memories), and tape drives. The storage adaptor 30 accesses data requested by clients 60 based at least partially on instructions from the operating system 20.

Each client 60 may interact with the file server 10 in accordance with a client/server model of information delivery. That is, clients 60 may request the services of the file server 10, and the file server 10 may return the results of the services requested by clients 60 by exchanging packets encapsulating, for example, Transmission Control Protocol (TCP)/Internet Protocol (IP) or another network protocol (e.g., Common Internet File System (CIFS) 55 and Network Files System (NFS) 45 format.

The storage operating system 20 implements a file system to logically organize data as a hierarchical structure of directories and files. The files (e.g. volumes 90) or other data batches may, in some embodiments, be grouped together and either grouped in the same location or distributed in different physical locations on the physical storage devices 160. In some embodiments, the volumes 90 will be regular volumes, dedicated WORM volumes 90, or compressed volumes 90.

### Mapping Inodes to Physical Volume Block Numbers

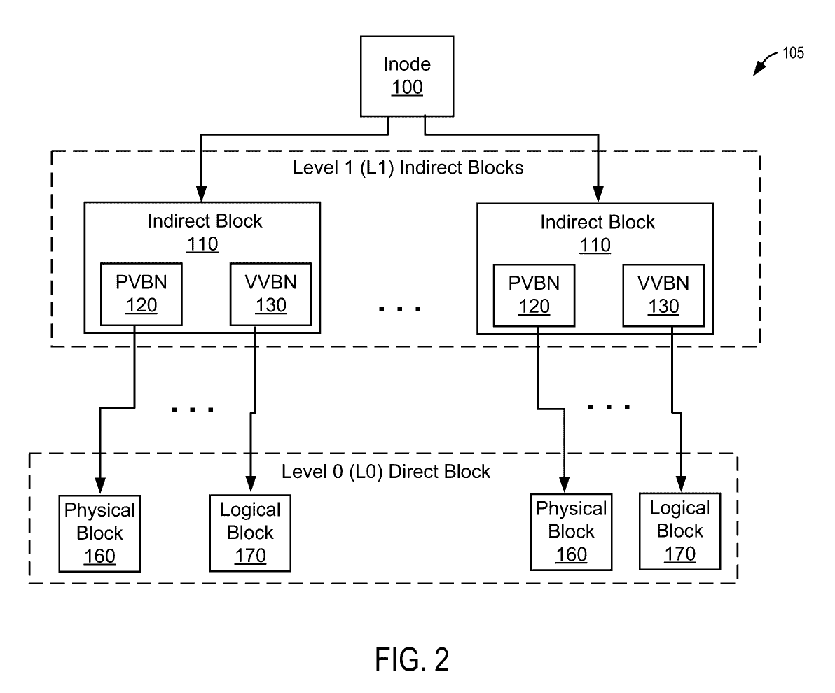

On some storage systems, every file (or volume) is mapped to data blocks using a tree of data block pointers. FIG. 2 shows an example of a tree 105 for a file. The file is assigned an inode 100, which references a tree of indirect blocks which eventually point to data blocks at the lowest level, or Level 0. The level just above data blocks that point directly to the location of the data blocks may be referred to as Level 1 (L1) indirect blocks 110. Each Level 1 indirect block 110 stores at least one physical volume block number (“PVBN”) 120 and a corresponding virtual volume block number (“VVBN”) 130, but generally includes many references of PVBN-VVBN pairs. To simplify description, only one PVBN-VVBN pair is shown in each indirect block 110 in FIG. 2; however, an actual implementation could include many PVBN-VVBN pairs in each indirect block. Each PVBN 120 references a physical block 160 in a storage device and the corresponding VVBN 130 references the associated logical block number 170 in the volume. The inode 100 and indirect blocks 110 are each shown pointing to only two lower-level blocks. It is to be understood, however, that an inode 100 and any indirect block can actually include a greater (or lesser) number of pointers and thus may refer to a greater (or lesser) number of lower-level blocks.

In some embodiments, although only L1 is shown for this file, there may be an L2, L3, L4, and further higher levels of indirect blocks such as blocks 110 that form a tree and eventually point to a PVBN-VVBN pair. The more levels, the greater storage space can be allocated for a single file, for example, if each physical storage block is 4K of user data. Therefore, in some embodiments, the inode 100 will point to an L2 indirect block, which could point to 255 L1 indirect blocks, which could therefore point to 255² physical blocks (VVBN-PVBN pairs), and so on.

For each volume managed by the storage server, the inodes of the files and directories in that volume are stored in a separate inode file. A separate inode is maintained for each volume. Each inode 100 in an inode file is the root of the tree 105 of a corresponding file or directory. The location of the inode file for each volume is stored in a Volume Information (“VolumeInfo”) block associated with that volume. The VolumeInfo block is a metadata container that contains metadata that applies to the volume as a whole. Examples of such metadata include, for example, the volume's name, type, size, any space guarantees to apply to the volume, the VVBN of the inode file of the volume, and information used for encryption and decryption, as discussed further below.

Level 1 Format with Intermediate Reference Block

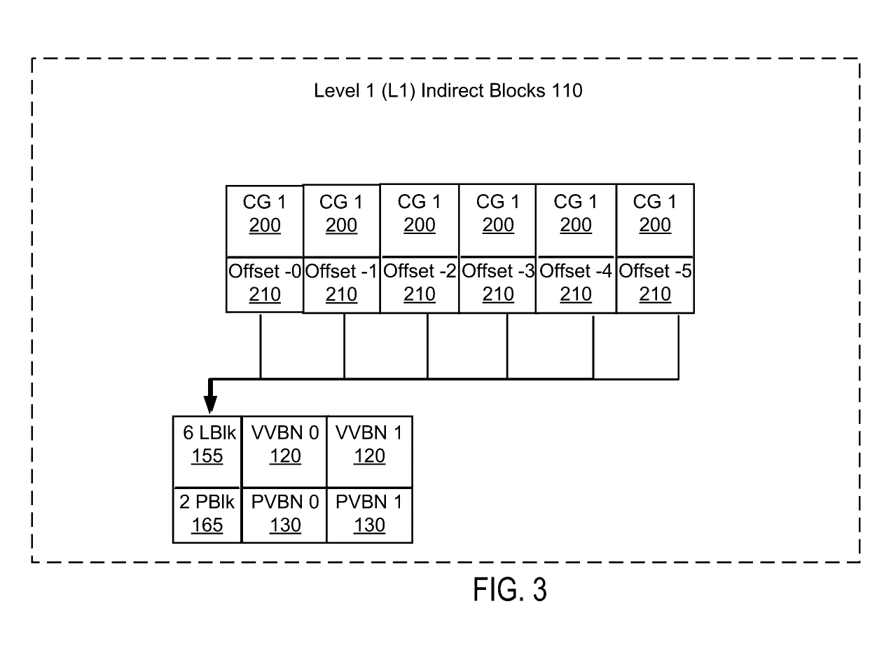

As illustrated in FIG. 3, the Level 1 or L1 tree indirect blocks 110 may, instead of only including block pointers that point directly to a PVBN 120 and VVBN 130 pair, also include intermediate referential blocks that then point to the block pointers with the PVBN-VVBN pair reference. This intermediate reference may be referred to as a “compression group” 200 herein, and allows groups of compressed data to be grouped together and assigned to a set of VVBN-PVBN pairs that are usually fewer in number than the original VVBN-PVBN pairs representing the uncompressed data. To identify each logical block of the compression group 200, an offset 210 is included for each pre-compression data block that has been compressed into a single data block. This indirection allows compression groups of varying sizes to be mapped to data blocks (e.g., VVBN-PVBN pairs) and portions of the compression group to be overwritten and mapped to new VVBN-PVBN pairs.

For example, FIG. 3 shows a compression group block that points to various VVBN and PVBN pairs. In this example, the intermediate reference (i.e. the compression group) includes a compression group 200 number and an offset 210. The compression group 200 number identifies an entire compressed set of physical data blocks that are compressed into a reduced number of data blocks at the physical level. The compression group 200 number points to the corresponding compression group 200 header in a level 1 block that includes the VVBN-PVBN pairs. The header includes the logical block length 155, or non-compressed number of blocks that comprise the compression group 200, and the physical block length 165 that includes the number of physical blocks (and corresponding VVBN-PVBN pairs) that the compression group has been compressed into.

The offset 210 refers to each individual pre-compression data block of the compression group 200. Accordingly, if the original compression group 200 contained eight blocks that are now compressed to two blocks, the compression group 200 will have a reference that points to a compression group in a corresponding PVBN-VVBN block, and each individual pre-compression block will have an offset numbered 0 through 8 or other suitable numbering scheme in the intermediate L1 block. Accordingly, the pre-compression data blocks will still be mapped to the inode 100, and the pre-compression data blocks will also be mapped to a single compression group 200. The compression group 200 will be then mapped to an L1 data block and set of VVBN 120 and PVBN 130 pairs, which in turn maps their locations to a physical location on a RAID group.

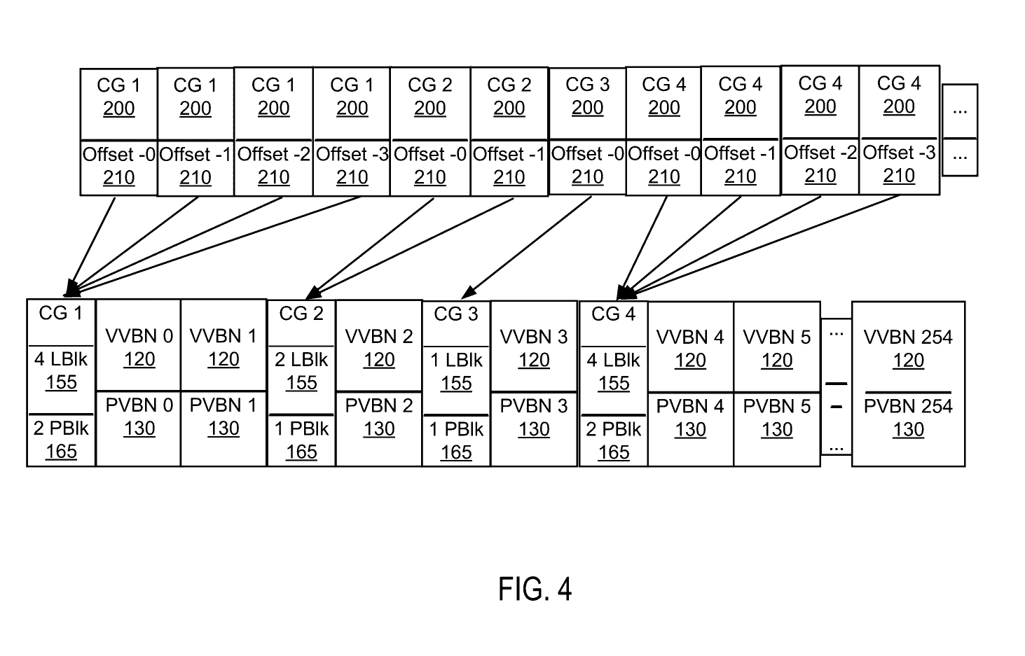

FIG. 4 illustrates another example with several compression groups mapped to VVBN-PVBN pairs in the same VVBN-PVBN L1 block. As illustrated, the compression group “1” has four logical blocks that are compressed into two physical blocks and VVBN-PVBN pairs. As this example will illustrate, the compression savings in the L1 block will provide free space in the VVBN-PVBN pairs for that data block, because not all of the VVBN-PVBN pairs will be used since the 255 slots (for example) for the logical, pre-compression blocks of the compression groups will be condensed into fewer VVBN-PVBN pairs. Also illustrated are non-compressed data blocks and pointers. For example, compression group “3” is not compressed. Rather, it only comprises one logical block 155 and therefore only points to one VVBN-PVBN pair.

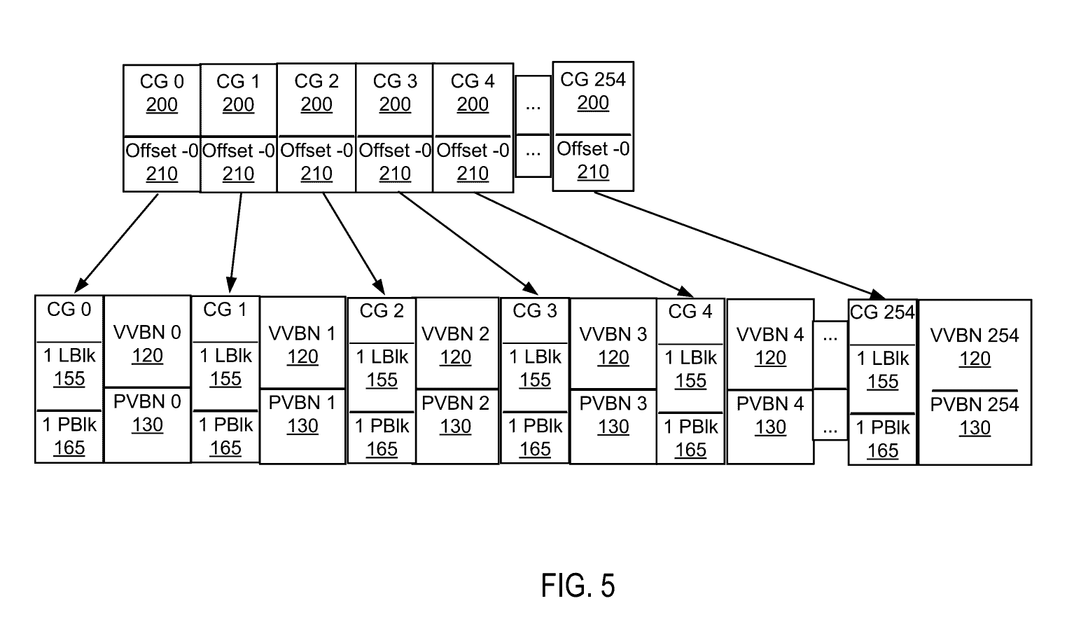

FIG. 5 illustrates an L1 block that points to non-compressed data blocks. As illustrated, each compression group 200 only references one corresponding VVBN-PVBN pair. Accordingly, in this example, 254 compression groups are mapped on a one-to-one basis to 254 VVBN pairs. Accordingly, as there is no compression, there is no space savings. As illustrated, each of the offset values is set to “0” because there is only one logical block per corresponding physical VVBN-PVBN pair. Additionally, each corresponding header block indicates there is “1” logical block (“LBlk”) 155 and “1” physical block (“PBlk”) 165.

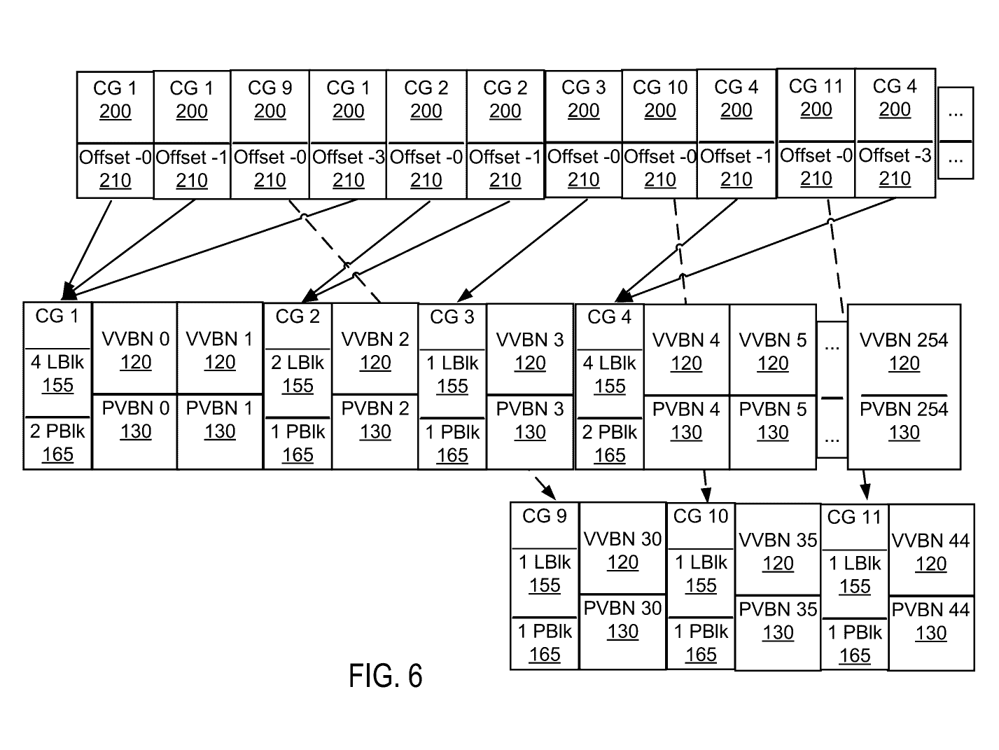

FIG. 6 illustrates an embodiment of a partial overwrite of a portion of three of the compression groups 200 illustrated. In this example, the dashed arrows indicate overwrites to the new blocks indicated below. Here, one block of compression group 200 “1” (at former offset −2) is rewritten and reassigned to compression group “9” below that is an uncompressed single block at pair VVBN-PVBN “30”. Similarly, two block of compression group 200 “4” (at former offsets −0 and −2) are rewritten and reassigned to compression groups 200 “10” and “11.” Compression groups 200 “10” and “11” both reference a single uncompressed VVBN-PVBN pair (VVBN “35” and VVBN “44”). Accordingly, as illustrated, portions of the compression groups 200 may be overwritten and assigned to unused VVBN-PVBN pairs that are free due to the compression. For instance, if 64 data block VVBN-PVBN pairs are saved with compression, the system can absorb the rewrites of 64 of the data blocks contained in the compression groups 200 before the entire data block must be read, modified, and re-compressed and re-written.

Accordingly, this provides an enormous time and space savings. Normally, compression is best suited for sequential workloads. Prior to the level one virtualization of compression groups disclosed herein, random writes with inline compression degenerate to the same performance model as partial block writes. The entire compression groups 200 would have been read in, then write resolved and then the compression groups 200 would have been recompressed and written out to disk. Therefore, in many systems partial compression group 200 overwrites were disallowed for inline compression. Accordingly, the systems and methods disclosed herein allow for partial overwrites of compression groups 200 that are not recompressed.

For instance, with an eight block compression group 200 size, there would be 32 compression groups 200 in one L1. Considering the scenario wherein in each of the 8 block compression groups 200 there are only 2 blocks that are saved, then there would be 2 blocks saved per compression group 200 and therefore 64 total saved blocks. Accordingly, the system could tolerate 64 partial overwrites of 4K in the L1 before the Read Modify Write command is issued.

In some embodiments, a counter in L1 may be utilized to track the partial overwrites of compression groups. For instance, therefore, once the counter reaches 64, the system may trigger read modify write for an entire L1 on the 65^{th} partial overwrite. In some embodiments, the counter can trigger decompression for a particular L1 once it reaches a threshold, for example, 40, 50, 65, 30 or other amounts of partial overwrites.

### CONCLUSIONS

It will be understood to those skilled in the art that the techniques described herein may apply to any type of special-purpose computer (e.g., file serving appliance) or general-purpose computer, including a standalone computer, embodied as a storage system. To that end, the filer can be broadly, and alternatively, referred to as a storage system.

The teachings of this disclosure can be adapted to a variety of storage system architectures including, but not limited to, a network-attached storage environment, a storage area network and disk assembly directly-attached to a client/host computer. The term “storage system” should, therefore, be taken broadly to include such arrangements.

In the illustrative embodiment, the memory comprises storage locations that are addressable by the processor and adapters for storing software program code. The memory comprises a form of random access memory (RAM) that is generally cleared by a power cycle or other reboot operation (i.e., it is “volatile” memory). The processor and adapters may, in turn, comprise processing elements and/or logic circuitry configured to execute the software code and manipulate the data structures. The storage operating system, portions of which are typically resident in memory and executed by the processing elements, functionally organizes the filer by, inter alia, invoking storage operations in support of a file service implemented by the filer. It will be apparent to those skilled in the art that other processing and memory means, including various computer readable media, may be used for storing and executing program instructions pertaining to the inventive technique described herein.

Similarly while operations may be depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

It should also be noted that the disclosure is illustrated and discussed herein as having a plurality of modules which perform particular functions. It should be understood that these modules are merely schematically illustrated based on their function for clarity purposes only, and do not necessary represent specific hardware or software. In this regard, these modules may be hardware and/or software implemented to substantially perform the particular functions discussed. Moreover, the modules may be combined together within the disclosure, or divided into additional modules based on the particular function desired. Thus, the disclosure should not be construed to limit the present disclosure, but merely be understood to illustrate one example implementation thereof.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

The various methods and techniques described above provide a number of ways to carry out the disclosure. Of course, it is to be understood that not necessarily all objectives or advantages described can be achieved in accordance with any particular embodiment described herein. Thus, for example, those skilled in the art will recognize that the methods can be performed in a manner that achieves or optimizes one advantage or group of advantages as taught herein without necessarily achieving other objectives or advantages as taught or suggested herein. A variety of alternatives are mentioned herein. It is to be understood that some embodiments specifically include one, another, or several features, while others specifically exclude one, another, or several features, while still others mitigate a particular feature by inclusion of one, another, or several advantageous features.

While this specification contains many specific implementation details, these should not be construed as limitations on the scope of any disclosures or of what may be claimed, but rather as descriptions of features specific to particular implementations of particular disclosures. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Furthermore, the skilled artisan will recognize the applicability of various features from different embodiments. Similarly, the various elements, features and steps discussed above, as well as other known equivalents for each such element, feature or step, can be employed in various combinations by one of ordinary skill in this art to perform methods in accordance with the principles described herein. Among the various elements, features, and steps some will be specifically included and others specifically excluded in diverse embodiments.

Although the application has been disclosed in the context of certain embodiments and examples, it will be understood by those skilled in the art that the embodiments of the application extend beyond the specifically disclosed embodiments to other alternative embodiments and/or uses and modifications and equivalents thereof

In some embodiments, the terms “a” and “an” and “the” and similar references used in the context of describing a particular embodiment of the application (especially in the context of certain of the following claims) can be construed to cover both the singular and the plural. The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (for example, “such as”) provided with respect to certain embodiments herein is intended merely to better illuminate the application and does not pose a limitation on the scope of the application otherwise claimed. No language in the specification should be construed as indicating any non-claimed element essential to the practice of the application.

Certain embodiments of this application are described herein. Variations on those embodiments will become apparent to those of ordinary skill in the art upon reading the foregoing description. It is contemplated that skilled artisans can employ such variations as appropriate, and the application can be practiced otherwise than specifically described herein. Accordingly, many embodiments of this application include all modifications and equivalents of the subject matter recited in the claims appended hereto as permitted by applicable law. Moreover, any combination of the above-described elements in all possible variations thereof is encompassed by the application unless otherwise indicated herein or otherwise clearly contradicted by context.

Particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results.

All patents, patent applications, publications of patent applications, and other material, such as articles, books, specifications, publications, documents, things, and/or the like, referenced herein are hereby incorporated herein by this reference in their entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that can be employed can be within the scope of the application. Thus, by way of example, but not of limitation, alternative configurations of the embodiments of the application can be utilized in accordance with the teachings herein. Accordingly, embodiments of the present application are not limited to that precisely as shown and described.

1. A method for providing a layer of virtualization to an indirect block to allow for variable sized compression groups to point to physical volume block numbers where the compression group is stored of a volume served by a storage system, the method comprising:
assembling a plurality of groups of storage devices of the storage system into an aggregate, the aggregate having a physical volume block number (pvbn) space defining a storage space provided by the storage devices; and
storing within the aggregate a plurality of virtual volumes of the storage system, each virtual volume having a file system and one or more files organized as buffer trees, the buffer trees utilizing indirect blocks, the indirect blocks having block pointers organized into compression groups, each of the compression groups referenced to a set of pvbn block pointers that are referenced to physical data blocks.

2. The method of claim 1, wherein the block pointers organized into compression groups include a data field storing an offset value identifying a logical data block of the compression group that represents a pre-compression data block.

3. The method of claim 1, wherein at least one of the compression groups is referenced to one block of uncompressed data.

4. The method of claim 1, wherein at least one the compression groups is referenced to a plurality of blocks of compressed data.

5. The method of claim 1, wherein the set of pvbn block pointers is also referenced to a virtual volume block number.

6. The method of claim 1, comprising the further step of reassigning a block pointer in at least one of the compression groups to a second set of pvbn block pointers during a partial overwrite of the compression group.

7. The method of claim 1, comprising the further steps of:
reading the physical data blocks referenced to at least one set of pvbn block pointers and compressing the physical data blocks into a set of compressed data blocks;
writing the set of compressed data blocks in a new location on the storage devices and referencing them to a new set of pvbn block pointers; and
reassigning the compression group referenced to the at least one set of pvbn block pointers to the new set of pvbn block pointers.

8. A non-transitory machine readable medium having stored thereon instructions for performing a method comprising machine executable code which when executed by at least one machine, causes the machine to:
assemble a plurality of groups of storage devices of the storage system into an aggregate, the aggregate having a physical volume block number (pvbn) space defining a storage space provide by the storage devices; and
store within the aggregate a plurality of virtual volumes of the storage system, each virtual volume having a file system organized as trees of indirect blocks, at least a subset of the indirect blocks having block pointers organized into compression groups, each of the compression groups referenced to a set of pvbn block pointers.

9. The non-transitory machine readable medium of claim 8, wherein the block pointers organized into compression groups include a data field storing an offset value identifying a logical data block of the compression group that represents a pre-compression data block.

10. The non-transitory machine readable medium of claim 8, wherein at least one of the compression groups is referenced to one block of uncompressed data.

11. The non-transitory machine readable medium of claim 8, wherein at least one the compression groups is referenced to a plurality of blocks of compressed data.

12. The non-transitory machine readable medium of claim 8, wherein the set of pvbn block pointers is also referenced to a virtual volume block number.

13. The non-transitory machine readable medium of claim 8, comprising the further step of reassigning a block pointer in a compression group to second set of pvbn block pointers during a partial overwrite of the compression group.

14. A computing device comprising:
a memory containing machine readable medium comprising machine executable code having stored thereon instructions for performing a method of providing a level of virtualization to an indirect block to allow for variable sized compression groups;
a processor coupled to the memory, the processor configured to execute the machine executable code to cause the processor to:
assemble a plurality of groups of storage devices of the storage system into an aggregate, the aggregate having a physical volume block number (pvbn) space defining a storage space provide by the storage devices; and
store within the aggregate a plurality of virtual volumes of the storage system, each virtual volume having a file system and one or more files organized using block pointers organized into compression groups, each of the compression groups referenced to a set of pvbn block pointers.

15. The computing device of claim 14, wherein the block pointers organized into compression groups include a data field storing an offset value identifying a logical data block of the compression group that represents a pre-compression data block.

16. The computing device of claim 14, wherein at least one of the compression groups is referenced to one block of uncompressed data.

17. The computing device of claim 14, wherein at least one the compression group is referenced to a plurality of blocks of compressed data.

18. The computing device of claim 14, wherein the set of pvbn block pointers is also referenced to a virtual volume block number.

19. The computing device of claim 14, comprising the further step of reassigning a block pointer in a compression group to second set of pvbn block pointers during a partial overwrite of the compression group.
